(19) United States
(12) Patent Application Publication
(10) Pub. No.: US 2026/0117047 A1
(43) Pub. Date: Apr. 30, 2026

(54) RESIN COMPOSITION AND ARTICLE MADE THEREFROM

(71) Applicant: Elite Electronic Material (Zhongshan) Co., Ltd., Zhongshan City (CN)

(72) Inventors: Changyuan LI, Zhongshan City (CN); Zhilong HU, Zhongshan City (CN); Xiangnan LI, Zhongshan City (CN); Lianhui CAI, Zhongshan City (CN); Xingfa CHEN, Zhongshan City (CN)

(21) Appl. No.: 18/968,210

(22) Filed: Dec. 4, 2024

(30) Foreign Application Priority Data
Oct. 31, 2024 (CN) 2024115484862
Nov. 21, 2024 (CN) 202411678781X

(51) Int. Cl. C08K 5/5357; C08K 5/3492; C08L 71/12

(52) U.S. Cl. CPC C08K 5/5357; C08K 5/34924; C08L 71/126; C08L 2201/02

(57) ABSTRACT

A resin composition includes 100 parts by weight of a vinyl group-containing polyphenylene ether resin; 10 parts by weight to 40 parts by weight of a crosslinking agent; and 20 parts by weight to 70 parts by weight of a phosphorus-containing flame retardant which comprises a phosphorus-containing compound represented by Formula (I). The resin composition can be used to make an article, which comprises a prepreg, a resin film, a laminate, a printed circuit board or a cured insulator, and achieves improvement in at least one of the properties including glass transition temperature, ratio of thermal expansion in Z-axis, T288 thermal resistance, flame retardancy, flame retardant migration, flame retardant detachment and bonding gap.

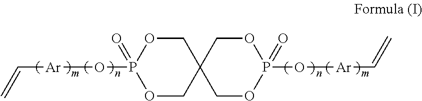

### CROSS-REFERENCE TO RELATED APPLICATION

This application claims the priority benefits of China Patent Application No. 2024115484862, filed on Oct. 31, 2024, and China Patent Application No. 202411678781X, filed on Nov. 21, 2024. The entirety of the above-mentioned patent application is hereby incorporated by reference herein and made a part of this specification.

### BACKGROUND

### 1. Field of the Disclosure

The present disclosure mainly relates to a resin composition and an article made therefrom, more particularly to a resin composition useful for preparing a prepreg, a resin film, a laminate (e.g., a copper-clad laminate), a printed circuit board or a cured insulator, and an article made therefrom.

### 2. Description of Related Art

Recently, the electronic technology has been developed towards higher density, lower power consumption and higher performance, thereby presenting more challenges to the high performance electronic materials. Printed circuit board (PCB), as a basic electronic component, is widely used in many fields such as mobile phones, computers, mobile communication, data centers, automobiles, industrial control and medicine, aeronautical and aerospace, etc., the technical level thereof and reliability having direct impacts on performance and stability of electronic equipment. Accordingly, there is an urgent need to develop a resin composition and an article thereof which can improve the properties of basic electronic components like printed circuit boards, such as meeting the demands in at least one property including glass transition temperature, ratio of thermal expansion in Z-axis, T288 thermal resistance and flame retardancy, as well as avoiding problems associated with flame retardant migration, flame retardant detachment or bonding gap.

### SUMMARY

To overcome the problems facing prior arts, particularly one or more of the above-mentioned technical problems of conventional materials, it is a primary object of the present disclosure to provide a resin composition and an article made therefrom which may overcome at least one of the above-mentioned technical problems.

In one aspect, the present disclosure provides a resin composition, which comprises:
100 parts by weight of a vinyl group-containing polyphenylene ether resin;
10 parts by weight to 40 parts by weight of a crosslinking agent; and
20 parts by weight to 70 parts by weight of a phosphorus-containing flame retardant, which comprises a phosphorus-containing compound represented by Formula (I):

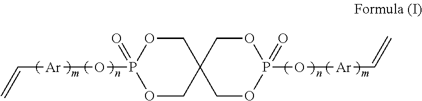

wherein m is 0 or 1, n is 0 or 1, and Ar group represents a divalent aromatic hydrocarbon group.

For example, in one embodiment, the vinyl group-containing polyphenylene ether resin comprises a vinylbenzyl group-terminated polyphenylene ether resin, a methacrylate group-terminated polyphenylene ether resin, an allyl group-terminated polyphenylene ether resin or a combination thereof.

For example, in one embodiment, the crosslinking agent comprises styrene, divinylbenzene, divinylnaphthalene, divinylbiphenyl, t-butyl styrene, bis(vinylbenzyl)ether, 1,2,4-trivinyl cyclohexane, bis(vinylphenyl)ethane, bis(vinylphenyl)hexane, bis(vinylphenyl) dimethyl ether, bis(vinylphenyl) dimethyl benzene, triallyl isocyanurate, triallyl cyanurate, diallyl bisphenol A, butadiene, decadiene, octadiene, vinylcarbazole, acrylate, styrene-divinylbenzene-ethylstyrene polymer or a combination thereof.

For example, in one embodiment, the divalent aromatic hydrocarbon group comprises a phenylene group, a naphthylene group, or a biphenylene group.

For example, in one embodiment, the phosphorus-containing compound represented by Formula (I) comprises any one phosphorus-containing compound of Formula (II), Formula (III) and Formula (IV) or a combination thereof:

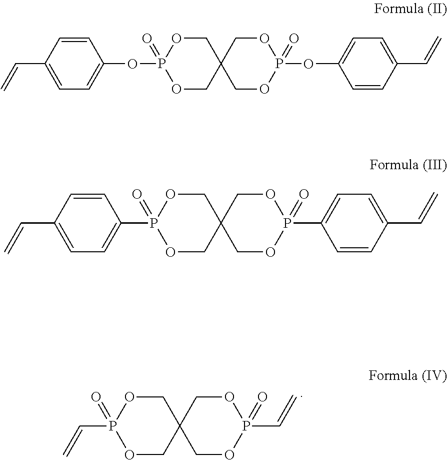

For example, in one embodiment, the resin composition further comprises a polyolefin resin, a styrene maleic anhydride resin, an epoxy resin, a phenolic resin, a benzoxazine resin, a cyanate ester resin, a polyester resin, a polyamide resin, a polyimide resin or a combination thereof.

For example, in one embodiment, the resin composition further comprises an amine curing agent, an inorganic filler, a curing accelerator, a polymerization inhibitor, a coloring agent, a solvent, a toughening agent, a silane coupling agent or a combination thereof.

In another aspect, to achieve the above-mentioned objects, the present disclosure further provides an article made from the aforesaid resin composition, including a prepreg, a resin film, a laminate, a printed circuit board or a cured insulator.

For example, in one embodiment, the article described above has at least one, more or all of the following properties:
a glass transition temperature as measured by using dynamic mechanical analysis by reference to IPC-TM-650 2.4.24.4 of greater than or equal to 215° C.;
a ratio of thermal expansion in Z-axis as measured by using thermal mechanical analysis by reference to IPC-TM-650 2.4.24.5 of less than or equal to 2.60%;
a time to delamination as measured by using thermal mechanical analysis by reference to IPC-TM-650 2.4.24.1 of greater than or equal to 60 minutes;
a flame retardancy of V-0 or V-1 as measured by reference to UL 94 rating;
no flame retardant migration as determined by visual inspection;
no flame retardant detachment as determined by scanning electron microscope inspection; and
no bonding gap as determined by scanning electron microscope inspection.

### BRIEF DESCRIPTION OF THE DRAWINGS

FIG. 1 is a picture showing a sample with flame retardant detachment.

FIG. 2 is a picture showing a sample without flame retardant detachment.

FIG. 3 and FIG. 4 are pictures showing a sample with bonding gap.

FIG. 5 is a picture showing a sample without bonding gap.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, the term “comprises,” “comprising,” “includes,” “including,” “has,” “having,” “encompasses,” “encompassing,” or any other variant thereof is construed as an open-ended transitional phrase intended to cover a non-exclusive inclusion. For example, a composition or article of manufacture that comprises a list of elements is not necessarily limited to only those elements but may include other elements not expressly listed or inherent to such composition or article of manufacture. Further, unless expressly stated to the contrary, the term “or” refers to an inclusive or and not to an exclusive or. For example, a condition “P or Q” is satisfied by any one of the following: P is true (or present) and Q is false (or not present), P is false (or not present) and Q is true (or present), and both P and Q are true (or present). In addition, whenever open-ended transitional phrases are used, such as “encompasses,” “encompassing,” “comprises,” “comprising,” “includes,” “including,” “has,” “having” or any other variant thereof, it is understood that close-ended transitional phrases such as “consisting of,” “composed by” and “remainder being” and partially open-ended transitional phrases such as “consisting essentially of,” “primarily consisting of,” “mainly consisting of,” “primarily containing,” “composed essentially of,” “essentially having,” etc. are also disclosed and included.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features or conditions presented as a numerical range or a percentage range are merely for convenience and brevity. Therefore, a numerical range or a percentage range should be interpreted as encompassing and specifically disclosing all possible subranges and individual numerals or values therein, particularly all integers therein. For example, a range of “1 to 8” should be understood as explicitly disclosing all subranges such as 1 to 7, 2 to 8, 2 to 6, 3 to 6, 4 to 8, 3 to 8 and so on, particularly all subranges defined by integers, as well as disclosing all individual values such as 1, 2, 3, 4, 5, 6, 7 and 8. Similarly, a range of “between 1 and 8” should be understood as explicitly disclosing all ranges such as 1 to 8, 1 to 7, 2 to 8, 2 to 6, 3 to 6, 4 to 8, 3 to 8 and so on and encompassing the end points of the ranges. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40 should be understood as covering a range of 39.50 to 40.49, and 40.0 should be understood as covering a range of 39.95 to 40.04.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X1, X2 and X3,” it is intended to disclose the situations of X is X1 and X is X1 and/or X2 and/or X3. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X1, X2 and X3” and Y is described as being “selected from a group consisting of Y1, Y2 and Y3,” the disclosure includes any combination of X is X1 or X2 or X3 and Y is Y1 or Y2 or Y3.

As used herein, “or a combination thereof” means “or any combination thereof” encompasses any combination of two or more of the listed elements, and “any” means “any one”, vice versa. For example, “a composition or an article made therefrom includes A, B, C or a combination thereof” or “a composition or an article made therefrom includes any one of A, B and C or a combination thereof” is construed to encompass the following situations: A is true (or present), and B and C are false (or not present); B is true (or present), and A and C are false (or not present); C is true (or present), and A and B are false (or not present); A and B are true (or present), and C is false (or not present); A and C are true (or present), and B is false (or not present); B and C are true (or present), and A is false (or not present); A, B and C are all true (or present), and other elements not expressly listed but inherent to such composition or article.

As used herein, the term “a composition comprises A, B and C, wherein A comprises a1, a2 or a3” means the same as “a composition comprises A, B and C, wherein A comprises a1, a2, a3 or a combination thereof”, that is, “a composition comprises A, B and C, wherein A comprises a1, a2, a3, a combination of a1 and a2, a combination of a1 and a3, a combination of a2 and a3, or a combination of a1, a2 and a3.”

As used herein, the term “isomer” means compounds that have the same molecular formula but differ in the bonding properties or order of their atoms or differ in the arrangement of their atoms in space.

Unless otherwise specified, the term “resin” is a widely used common name of a synthetic polymer and is construed in the present disclosure as comprising monomer and its combination, polymer and its combination or a combination of monomer and its polymer, but not limited thereto.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property. In addition, as used herein, a mixture may include two or more compounds and may include a copolymer or auxiliaries, but not limited thereto.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto.

A homopolymer refers to a chemical substance formed by a single compound via polymerization, addition polymerization or condensation polymerization. A copolymer refers to a chemical substance formed by two or more compounds via polymerization, addition polymerization or condensation polymerization and may comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as the structures shown below. Unless otherwise specified, according to the present disclosure, a prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured.

The block copolymers can be, such as a structure of

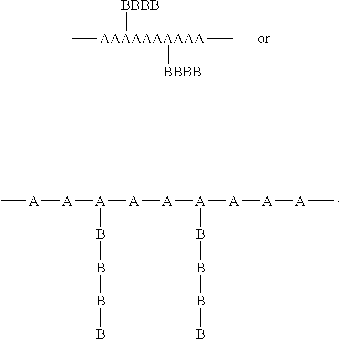

The term “polymer” includes but is not limited to an oligomer. An oligomer refers to a polymer with 2 to 20, typically 2 to 5, repeating units.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from homopolymerizing a resin, a product derived from copolymerizing a resin and other resins, etc. For example, such as but not limited thereto, a modification may refer to replacing a hydroxyl group with a vinyl group via a chemical reaction, or obtaining a terminal hydroxyl group from a chemical reaction of a terminal vinyl group and p-aminophenol.

Unless otherwise specified, an alkyl group, an alkenyl group and a hydrocarbyl group described herein are construed to encompass various isomers thereof. For example, a propyl group is construed to encompass n-propyl and iso-propyl.

Unless otherwise specified, as used herein, the term “vinyl group-containing”, such as in vinyl group-containing polyphenylene ether resin, refers to the presence of an ethylenic carbon-carbon double bond (C═C) or a functional group derived therefrom in a compound. Therefore, examples of “vinyl group-containing” may include, but not limited to, a structure containing a vinyl group, an allyl group, a vinylbenzyl group, a methacrylate group or the like. Unless otherwise specified, the position of the aforesaid functional group is not particularly limited and may be located at the terminal of a long-chain structure.

The unsaturated bond described herein, unless otherwise specified, refers to a reactive unsaturated bond, such as but not limited to an unsaturated double bond with the potential of being crosslinked with other functional groups, such as an unsaturated carbon-carbon double bond with the potential of being crosslinked with other functional groups, but not limited thereto.

As used herein, part(s) by weight represents weight part(s) in any weight unit, such as but not limited to kilogram, gram, pound and so on. For example, 100 parts by weight of a vinyl group-containing polyphenylene ether resin may represent 100 kilograms of the vinyl group-containing polyphenylene ether resin or 100 pounds of the vinyl group-containing polyphenylene ether resin.

The following embodiments and examples are illustrative in nature and are not intended to limit the present disclosure and its application. In addition, the present disclosure is not bound by any theory described in the background and summary above or the following embodiments or examples. Unless otherwise specified, processes, reagents and conditions described in the examples are those known in the art.

As described above, the present disclosure provides a resin composition, comprising the following components:
100 parts by weight of a vinyl group-containing polyphenylene ether resin;
10 parts by weight to 40 parts by weight of a crosslinking agent; and
20 parts by weight to 70 parts by weight of a phosphorus-containing flame retardant, which comprises a phosphorus-containing compound represented by Formula (I):

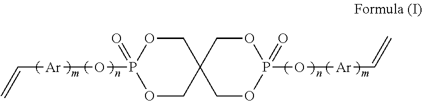

wherein m is 0 or 1, n is 0 or 1, and Ar group represents a divalent aromatic hydrocarbon group.

The vinyl group-containing polyphenylene ether resin suitable for the present disclosure is not particularly limited and may include any one or more vinyl group-containing polyphenylene ether resins useful for making a prepreg, a resin film, a laminate, a printed circuit board or a cured insulator, such as any one or more commercial products, products prepared by the Applicant or a combination thereof. For example, in one embodiment, the vinyl group-containing polyphenylene ether resin used herein refers to a polyphenylene ether compound or mixture having an ethylenic carbon-carbon double bond (C═C) or a functional group derived therefrom. Examples of the ethylenic carbon-carbon double bond (C═C) or the functional group derived therefrom may include, but not limited to, a structure containing a vinyl group, a vinylene group, an allyl group, a vinylbenzyl group, a methacrylate group or the like. Unless otherwise specified, the position of the aforesaid functional group is not particularly limited and may be located at the terminal of a long-chain structure. In other words, the vinyl group-containing polyphenylene ether resin described herein represents a polyphenylene ether resin containing a reactive vinyl group or a functional group derived therefrom, examples including but not limited to a polyphenylene ether resin containing a vinyl group, a vinylene group, an allyl group, a vinylbenzyl group, or a methacrylate group. For example, in one embodiment, the vinyl group-containing polyphenylene ether resin described herein comprises a vinylbenzyl-terminated polyphenylene ether resin, a methacrylate-terminated polyphenylene ether resin (i.e., methacryl-terminated polyphenylene ether resin), an allyl-terminated polyphenylene ether resin or a combination thereof.

The vinyl group-containing polyphenylene ether resin of the present disclosure has an unsaturated C═C double bond and a phenylene ether skeleton, wherein the unsaturated C═C double bond is a reactive group which may perform self-polymerization under heat and may also perform free radical polymerization with other components containing an unsaturated bond in the resin composition and finally result in crosslinking and curing. Preferably, the vinyl group-containing polyphenylene ether resin comprises a vinyl group-containing polyphenylene ether resin with 2,6-dimethyl substitution in its phenylene ether skeleton, wherein the methyl groups form steric hindrance to prevent the oxygen atom of the ether group from forming a hydrogen bond or Van der Waals force to absorb moisture, thereby achieving better dielectric properties.

For example, in one embodiment, the vinyl group-containing polyphenylene ether resin comprises, but not limited to, a vinylbenzyl group-terminated polyphenylene ether resin with a number average molecular weight of about 1200 (such as OPE-2st 1200, available from Mitsubishi Gas Chemical Co., Inc.), a vinylbenzyl group-terminated polyphenylene ether resin with a number average molecular weight of about 2200 (such as OPE-2st 2200, available from Mitsubishi Gas Chemical Co., Inc.), a vinylbenzyl group-terminated polyphenylene ether resin with a number average molecular weight of about 2400 to 2800 (such as a vinylbenzyl group-containing bisphenol A polyphenylene ether resin), a methacrylate group-terminated polyphenylene ether resin with a number average molecular weight of about 1900 to 2300 (such as SA9000, available from Sabic), a vinyl group-terminated polyphenylene ether resin with a number average molecular weight of about 2200 to 3000, or a combination thereof. The vinyl group-terminated polyphenylene ether resin may include various polyphenylene ether resins disclosed in the US Patent Application Publication No. 20160185904A1, all of which are incorporated herein by reference in their entirety.

Relative to 100 parts by weight of the vinyl group-containing polyphenylene ether resin, the resin composition of the present disclosure further comprises 10 parts by weight to 40 parts by weight of a crosslinking agent. For example, relative to 100 parts by weight of the vinyl group-containing polyphenylene ether resin, the resin composition of the present disclosure may comprise 10, 15, 20, 25, 30, 35 or 40 parts by weight of a crosslinking agent.

In one embodiment, the crosslinking agent comprises a vinyl group-containing crosslinking agent. For example, in one embodiment, the vinyl group-containing crosslinking agent used herein refers to a compound, a polymer or a mixture containing an ethylenic carbon-carbon double bond (C═C) or a functional group derived therefrom in the molecule and being able to undergo a crosslinking reaction with a vinyl group-containing polyphenylene ether resin. In addition, the vinyl group-containing crosslinking agent is different from the aforesaid vinyl group-containing polyphenylene ether resin.

For example, the vinyl group-containing crosslinking agent refers to a vinyl group-containing compound or polymer with a molecular weight of less than or equal to 5,000, preferably between 100 and 4,000 and more preferably between 100 and 3,000. The vinyl group-containing crosslinking agent comprises but is not limited to styrene, divinylbenzene, divinylnaphthalene, divinylbiphenyl, t-butyl styrene, bis(vinylbenzyl)ether, 1,2,4-trivinylcyclohexane (TVCH), bis(vinylphenyl) ethane (BVPE), bis(vinylphenyl)hexane, bis(vinylphenyl) dimethyl ether, bis(vinylphenyl) dimethyl benzene, triallyl isocyanurate (TAIC), triallyl cyanurate (TAC), diallyl bisphenol A, butadiene, decadiene, octadiene, vinylcarbazole, acrylate, styrene-divinylbenzene-ethylstyrene polymer or a combination thereof. These components should be construed as including their isomers or polymers.

Relative to 100 parts by weight of the vinyl group-containing polyphenylene ether resin, the resin composition of the present disclosure further comprises 20 parts by weight to 70 parts by weight of a phosphorus-containing flame retardant. For example, relative to 100 parts by weight of the vinyl group-containing polyphenylene ether resin, the resin composition of the present disclosure may comprise 10, 20, 30, 40, 50, 60 or 70 parts by weight of a phosphorus-containing flame retardant. As used herein, the phosphorus-containing flame retardant comprises a compound represented by Formula (I):

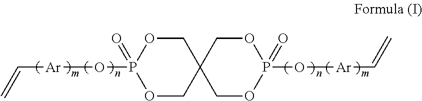

wherein m is 0 or 1, n is 0 or 1, and Ar group represents a divalent aromatic hydrocarbon group.

For example, in one embodiment, the type of the divalent aromatic hydrocarbon group is not particularly limited and may be for example a phenylene group, a naphthylene group, or a biphenylene group, but not limited thereto.

For example, in one embodiment, the phenylene group may be 1,2-phenylene group, 1,3-phenylene group or 1,4-phenylene group, preferably 1,4-phenylene group, but not limited thereto. The naphthylene group may be 1,2-naphthylene group, 1,3-naphthylene group, 1,4-naphthylene group, 1,5-naphthylene group, 1,6-naphthylene group, 1,7-naphthylene group, 1,8-naphthylene group, 2,3-naphthylene group, 2,6-naphthylene group or 2,7-naphthylene group, particularly 1,5-naphthylene group or 1,6-naphthylene group, but not limited thereto. The biphenylene group may be 2,2′-biphenylene group, 2,3′-biphenylene group, 2,4′-biphenylene group, 3,3′-biphenylene group, 3,4′-biphenylene group or 4,4′-biphenylene group, particularly 4,4′-biphenylene group, but not limited thereto.

For example, in one embodiment, in the structure of Formula (I), Ar group may be an unsubstituted divalent aromatic hydrocarbon group.

For example, in another embodiment, in the structure of Formula (I), Ar group may be a substituted divalent aromatic hydrocarbon group. For example, in one embodiment, the substituent on the Ar group may be an alkyl group with 1 to 4 carbon atoms, an alkoxy group with 1 to 4 carbon atoms, an alkylamino group with 1 to 4 carbon atoms, a phenyl group or a benzyl group, but not limited thereto.

In the structure of Formula (I), if m is 1, n may be 0 or 1. When n is 0, each phosphorus atom (P) is directly bonded to the Ar group. When n is 1, each phosphorus atom (P) is bonded to the Ar group through an oxygen atom (O). For example, in one embodiment, when m is 1 and n is 0, a terminal vinyl group and a phosphorus atom in the structure of Formula (I) may be located at any two substitution positions of the divalent aromatic hydrocarbon group (i.e., Ar group). For example, in another embodiment, when m is 1 and n is 1, a terminal vinyl group and an oxygen atom in the structure of Formula (I) may be located at any two substitution positions of the divalent aromatic hydrocarbon group (i.e., Ar group).

In addition, in the structure of Formula (I), if m is 0, n may be 0 or 1. For example, in one embodiment, when m is 0 and n is 0, a terminal vinyl group in the structure of Formula (I) is directly bonded to the phosphorus atom (P).

For example, in one embodiment, the compound represented by Formula (I) comprises any one phosphorus-containing compound of Formula (II), Formula (III) and Formula (IV) or a combination thereof:

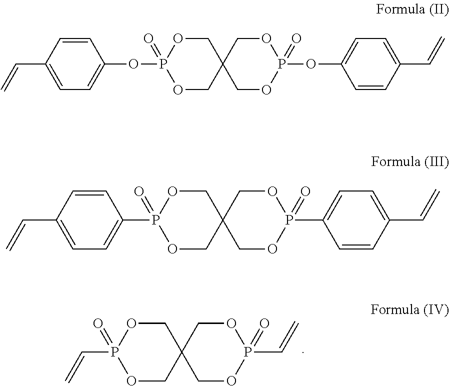

It can be observed from the structure of Formula (I), Formula (II), Formula (III) or Formula (IV) that, in the phosphorus-containing flame retardant of the resin composition according to the present disclosure, a phosphorus-containing heterospirocyclic structure has structural symmetry and good thermal stability, and it is rich in phosphorus elements and carbon elements and has good flame retardancy. In addition, the phosphorus-containing compound of Formula (I), Formula (II), Formula (III) or Formula (IV) has reactive double bonds at two ends, which may be crosslinked with a resin to form an interconnected network, allowing materials such as copper-clad laminates to have high glass transition temperature and lower ratio of thermal expansion. For example, in one embodiment, the phosphorus-containing compound of Formula (I), Formula (II), Formula (III) or Formula (IV) has a phosphorus content of 9% to 16% (including 9%, 10%, 11%, 12%, 13%, 14%, 15% or 16%), such as a phosphorus content of between 13% and 16%, but not limited thereto.

On the other hand, the phosphorus-containing flame retardant used in the resin composition disclosed herein belongs to a reactive phosphorus-containing flame retardant. Compared with an additive phosphorus-containing flame retardant, the reactive phosphorus-containing flame retardant can participate in a crosslinking reaction, capable of effectively preventing the migration and precipitation, detachment or bonding gap of the phosphorus-containing flame retardant in materials such as copper-clad laminates.

For example, the phosphorus-containing compound of Formula (I), Formula (II), Formula (III) or Formula (IV) contains at least two vinyl reactive functional groups that can participate in a reaction and therefore can also be used as a crosslinking agent. For example, the phosphorus-containing compound of Formula (I), Formula (II), Formula (III) or Formula (IV) in a vinyl group-containing polyphenylene ether resin system can achieve improvements in one, more or all properties including glass transition temperature, ratio of thermal expansion in Z-axis, T288 thermal resistance, flame retardancy, flame retardant migration, flame retardant detachment and bonding gap.

The phosphorus-containing flame retardant used in the resin composition disclosed herein may be prepared by various methods.

For example, in one embodiment, the phosphorus-containing flame retardant used in the resin composition disclosed herein may be prepared by the methods as described in Synthesis Examples 1 to 3.

### Synthesis Example 1

In a three-necked flask inserted with a thermometer and a condensation tube, 2 moles (about 272 grams) of pentaerythritol and 6 moles (about 920 grams) of phosphorus oxychloride were added, and the resulting solution was heated to reflux for 6 hours. After the reaction was completed, excess phosphorus oxychloride was removed by rotary evaporation under reduced pressure, so as to obtain a white solid intermediate product, pentaerythritol diphosphate diphosphoryl chloride, and the yield of pentaerythritol diphosphate diphosphoryl chloride was about 68%.

In a three-neck flask inserted with a thermometer and a condensation tube, 1 mole of pentaerythritol diphosphate diphosphoryl chloride (about 296 grams) and a proper amount of chlorobenzene solvent were added, followed by adding 3 moles of 4-hydroxystyrene (about 360 grams) and a proper amount of a deacid reagent (N,N-diisopropylethylamine), heating to 60° C. and reacting for 16 hours. After the reaction was completed, excess 4-hydroxystyrene was removed by rotary evaporation, so as to obtain a white solid product, which is the phosphorus-containing flame retardant of Formula (II), and the yield was about 50%.

In addition, the phosphorus-containing flame retardant prepared in Synthesis Example 1 was purified and then subjected to Fourier-transform infrared spectroscopy (FTIR), nuclear magnetic resonance spectroscopy (¹H NMR and ³¹P NMR) and liquid chromatography-mass spectrometry (LC-MS) analysis. From the FTIR spectrum, it can be observed that the absorption peaks at 1600 cm⁻¹ and 1502 cm⁻¹ indicate the presence of a benzene ring skeleton in the phosphorus-containing compound; the absorption peaks at 3078 cm⁻¹ and 1630 cm⁻¹ correspond to C═C—H bond, the absorption peak at 1300 cm-1 corresponds to P═O bond; the absorption peaks at 1152 cm⁻¹ and 1017 cm⁻¹ correspond to P—O—C bond; and the absorption peaks at 852 cm⁻¹ and 771 cm⁻¹ are attributed to vibrations of the pentaerythritol spirocarbon skeleton, which are consistent with the expected structure of Synthesis Example 1, preliminarily confirming that the phosphorus-containing compound of Formula (II) has been synthesized. From the ¹H NMR spectrum, it can be observed that this phosphorus-containing flame retardant has six different chemical environments for hydrogen atoms, each corresponding to the chemical shifts of hydrogen atoms at six different positions in the ¹H NMR spectrum, wherein the chemical shift (6) at 4.2 to 5.0 ppm corresponds to hydrogen atoms in the —CH₂— groups in pentaerythritol; the chemical shift at 5.2 to 6.0 ppm corresponds to hydrogen atoms in the terminal vinyl —CH₂ groups; the chemical shift at 6.5 to 7.0 ppm corresponds to hydrogen atoms in the terminal vinyl —CH— groups; and the chemical shift at 7.3 to 7.6 ppm corresponds to hydrogen atoms in two types of —CH— groups in the benzene ring (adjacent to the C on the benzene ring in the —C—O— bond in vinylphenoxy group and adjacent to the C on the benzene ring in the —C—C— bond in vinylphenoxy group, respectively), which are sufficient to confirm that the phosphorus-containing compound of Formula (II) has been synthesized. In addition, from the above structure, it can be confirmed that the phosphorus-containing flame retardant prepared in Synthesis Example 1 has two phosphorus atoms in the same chemical environment. Correspondingly, from the results of the ³¹P NMR spectrum of the phosphorus-containing flame retardant prepared in Synthesis Example 1, it can be observed that only one peak at a chemical shift at −13.666 ppm, indicating that there is only one chemical environment for the phosphorus atoms in this phosphorus-containing flame retardant, which also indicates that the phosphorus-containing compound has a symmetrical structure, consistent with the expected structure of Synthesis Example 1. The molecular weight of the tested compound is calculated according to the LC-MS spectrum to be 464.35. Compared to the theoretical molecular weight calculated from the molecular structure of the phosphorus-containing flame retardant, it can be seen that the measured molecular weight matches the theoretical molecular weight, indicating that the phosphorus-containing flame retardant has been synthesized.

### Synthesis Example 2

The pentaerythritol diphosphate diphosphoryl chloride was obtained by reference to the method of Synthesis Example 1. In the absence of a deacid reagent, 3 moles of 4-styryl magnesium chloride (about 495 grams) and 1 mole of pentaerythritol diphosphate diphosphoryl chloride (about 296 grams) were heated to 60° C. in a three-neck flask and reacted for 8 hours. After the reaction was completed, excess 4-styryl magnesium chloride was removed by rotary evaporation under reduced pressure, so as to obtain a white solid product, which is the phosphorus-containing flame retardant of Formula (III), and the yield was about 45%.

### Synthesis Example 3

The pentaerythritol diphosphate diphosphoryl chloride was obtained by reference to the method of Synthesis Example 1. In the absence of a deacid reagent, 3 moles of vinyl magnesium chloride (about 260 grams) and 1 mole of pentaerythritol diphosphate diphosphoryl chloride (about 296 grams) were heated to 60° C. in a three-neck flask and reacted for 8 hours. After the reaction was completed, excess vinyl magnesium chloride was removed by rotary evaporation under reduced pressure, so as to obtain a white solid product, which is the phosphorus-containing flame retardant of Formula (IV), and the yield was about 50%.

In addition to the aforesaid vinyl group-containing polyphenylene ether resin, crosslinking agent and phosphorus-containing flame retardant, the resin composition of the present disclosure may also optionally comprise other components.

For example, in one embodiment, the resin composition of the present disclosure may further comprise a polyolefin resin, a styrene maleic anhydride resin, an epoxy resin, a phenolic resin, a benzoxazine resin, a cyanate ester resin, a polyester resin, a polyamide resin, a polyimide resin or a combination thereof.

For example, in one embodiment, the resin composition according to the present disclosure may further comprise a polyolefin resin. For example, relative to 100 parts by weight of the vinyl group-containing polyphenylene ether resin, the resin composition according to the present disclosure may comprise 5 parts by weight to 30 parts by weight of a polyolefin resin. For example, relative to 100 parts by weight of the vinyl group-containing polyphenylene ether resin, the amount of polyolefin resin may be 5, 10, 15, 20, 25 or 30 parts by weight, but not limited thereto.

The polyolefin resin suitable for the present disclosure is not particularly limited and may include any one or more polyolefin resins useful for making a prepreg, a resin film, a laminate, a printed circuit board or a cured insulator, such as any one or more commercial products, products prepared by the Applicant or a combination thereof. For example, the polyolefin resin suitable for the resin composition of the present disclosure includes but is not limited to a diene polymer, a monoene polymer, a hydrogenated diene polymer or a combination thereof. The diene refers to a hydrocarbon compound containing two unsaturated C═C double bonds in the molecule, and the monoene refers to a hydrocarbon compound containing one unsaturated C═C double bond in the molecule. The polyolefin resin suitable for the resin composition of the present disclosure comprises, such as but not limited to, any one of polybutadiene, polyisoprene, styrene-butadiene copolymer, styrene-isoprene copolymer, styrene-butadiene-divinylbenzene polymer, maleic anhydride-adducted styrene-butadiene copolymer, vinyl-polybutadiene-urethane polymer, maleic anhydride-adducted polybutadiene, polymethylstyrene, hydrogenated polybutadiene, hydrogenated polyisoprene, hydrogenated styrene-butadiene-divinylbenzene polymer, hydrogenated maleic anhydride-adducted styrene-butadiene copolymer, hydrogenated styrene-butadiene copolymer, hydrogenated styrene-isoprene copolymer or a combination thereof.

According to the present disclosure, for example, the styrene maleic anhydride resin may be any styrene maleic anhydride resin known in the field to which this disclosure pertains, wherein the molar ratio of styrene (St) to maleic anhydride (MA) may be 1/1, 2/1, 3/1, 4/1, 6/1, 8/1 or 12/1. Examples include but are not limited to styrene maleic anhydride copolymers such as SMA-1000, SMA-2000, SMA-3000, EF-30, EF-40, EF-60 and EF-80 available from Cray Valley, or styrene maleic anhydride copolymers such as C400, C500, C700 and C900 available from Polyscope.

According to the present disclosure, for example, the epoxy resin may be any epoxy resins known in the field to which this disclosure pertains. In terms of improving the heat resistance of the resin composition, the epoxy resin may include, but not limited to, any one of bisphenol A epoxy resin, bisphenol F epoxy resin, bisphenol S epoxy resin, bisphenol AD epoxy resin, novolac epoxy resin, trifunctional epoxy resin, tetrafunctional epoxy resin, multifunctional novolac epoxy resin, dicyclopentadiene (DCPD) epoxy resin, phosphorus-containing epoxy resin, p-xylene epoxy resin, naphthalene epoxy resin (e.g., naphthol epoxy resin), benzofuran epoxy resin, isocyanate-modified epoxy resin, or a combination thereof. According to the present disclosure, for example, the novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin or o-cresol novolac epoxy resin. According to the present disclosure, for example, the phosphorus-containing epoxy resin may be DOPO (9,10-dihydro-9-oxa-10-phosphaphenanthrene-10-oxide) epoxy resin, DOPO-HQ epoxy resin or a combination thereof. The DOPO epoxy resin may be any one or more selected from DOPO-containing phenol novolac epoxy resin, DOPO-containing o-cresol novolac epoxy resin and DOPO-containing bisphenol-A novolac epoxy resin; the DOPO-HQ epoxy resin may be any one or more selected from DOPO-HQ-containing phenol novolac epoxy resin, DOPO-HQ-containing o-cresol novolac epoxy resin and DOPO-HQ-containing bisphenol-A novolac epoxy resin, but not limited thereto.

According to the present disclosure, for example, the phenol resin may be any phenol resins known in the field to which this disclosure pertains. Examples include but are not limited to novolac resin or phenoxy resin, wherein the novolac resin includes phenol novolac resin, o-cresol novolac resin, bisphenol A novolac resin, naphthol novolac resin, biphenyl novolac resin, and dicyclopentadiene phenol resin, but not limited thereto.

According to the present disclosure, for example, the benzoxazine resin may be any benzoxazine resins known in the field to which this disclosure pertains. Examples include but are not limited to bisphenol A benzoxazine resin, bisphenol F benzoxazine resin, phenolphthalein benzoxazine resin, dicyclopentadiene benzoxazine resin, phosphorus-containing benzoxazine resin, diamino benzoxazine resin and phenyl group-modified, vinyl group-modified or allyl group-modified benzoxazine resin. Commercially available products include LZ-8270 (phenolphthalein benzoxazine resin), LZ-8298 (phenolphthalein benzoxazine resin), LZ-8280 (bisphenol F benzoxazine resin) and LZ-8290 (bisphenol A benzoxazine resin) available from Huntsman, and KZH-5031 (vinyl-modified benzoxazine resin) and KZH-5032 (phenyl-modified benzoxazine resin) available from Kolon Industries Inc. The diamino benzoxazine resin may be diaminodiphenylmethane benzoxazine resin, diaminodiphenyl ether benzoxazine resin, diaminodiphenyl sulfone benzoxazine resin, diaminodiphenyl sulfide benzoxazine resin or a combination thereof, but not limited thereto.

According to the present disclosure, for example, the cyanate ester resin may be any cyanate ester resins known in the field to which this disclosure pertains, such as a compound having an Ar—O—C≡N structure, wherein Ar may be a substituted or unsubstituted aromatic group. In terms of improving the thermal resistance of the resin composition, examples include but are not limited to novolac cyanate ester resin, bisphenol A cyanate ester resin, bisphenol F cyanate ester resin, dicyclopentadiene-containing cyanate ester resin, naphthalene-containing cyanate ester resin, phenolphthalein cyanate ester resin, adamantane cyanate ester resin, fluorene cyanate ester resin or a combination thereof. The novolac cyanate ester resin may be bisphenol A novolac cyanate ester resin, bisphenol F novolac cyanate ester resin or a combination thereof. For example, the cyanate ester resin may be available under the product name Primaset PT-15, PT-30S, PT-60S, BA-200, BA-230S, BA-3000S, BTP-2500, BTP-6020S, DT-4000, DT-7000, ULL950S, HTL-300, CE-320, LVT-50, or LeCy sold by Lonza.

According to the present disclosure, for example, the polyester resin may be any polyester resins known in the field to which this disclosure pertains. Examples include but are not limited to a dicyclopentadiene-containing polyester resin and a naphthalene-containing polyester resin. Examples include, but not limited to, HPC-8000 or HPC-8150 available from D.I.C. Corporation.

According to the present disclosure, for example, the polyamide resin may be any polyamide resins known in the field to which this disclosure pertains. Examples include but are not limited to various commercially available polyamide resin products.

According to the present disclosure, for example, the polyimide resin may be any polyimide resins known in the field to which this disclosure pertains. Examples include but are not limited to various commercially available polyimide resin products.

For example, in one embodiment, the resin composition further comprises an amine curing agent, an inorganic filler, a curing accelerator, a polymerization inhibitor, a coloring agent, a solvent, a toughening agent, a silane coupling agent or a combination thereof.

According to the present disclosure, for example, the amine curing agent may be any amine curing agents known in the field to which this disclosure pertains. Examples include but are not limited to any one or a combination of diamino diphenyl sulfone, diamino diphenyl methane, diamino diphenyl ether, diamino diphenyl sulfide and dicyandiamide (DICY). Unless otherwise specified, in the resin composition of the present disclosure, relative to 100 parts by weight of the vinyl group-containing polyphenylene ether resin, the amount of the amine curing agent is not particularly limited, such as may be 1 part by weight to 15 parts by weight, such as but not limited to 1 part by weight, 4 parts by weight, 7.5 parts by weight, 12 parts by weight or 15 parts by weight.

In one embodiment, the resin composition comprises an inorganic filler. The inorganic filler may be any one or more fillers useful for making a resin film, a prepreg, a laminate, a printed circuit board or a cured insulator. The inorganic filler may be silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, mica, boehmite (AlOOH), calcined talc, talc, silicon nitride, calcined kaolin, or a combination thereof, but not limited thereto. The inorganic filler may be spherical, fibrous, plate-like, particulate, flake-like or whisker-like. The inorganic filler may be pre-treated by a silane coupling agent (particularly amino group-containing silane coupling agent). The inorganic filler may be spherical silica pre-treated by an amino group-containing silane coupling agent. The amount of the inorganic filler is not particularly limited. In one embodiment, relative to 100 parts by weight of all the resins in the resin composition (excluding silane coupling agents, curing accelerators, solvents and inorganic fillers), the resin composition may comprise 20 parts by weight to 300 parts by weight of an inorganic filler, preferably 50 parts by weight to 250 parts by weight, but not limited thereto.

In one embodiment, the resin composition comprises a curing accelerator. The curing accelerator may comprise a catalyst, such as a Lewis base or a Lewis acid. The Lewis base may comprise imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP), 4-dimethylamino pyridine (DMAP), or a combination thereof, but not limited thereto. The Lewis acid may comprise metal salt compounds, such as those of manganese, iron, cobalt, nickel, copper and zinc, particularly metal catalysts such as zinc octanoate and cobalt octanoate, but not limited thereto. The curing accelerator may comprise a curing initiator (i.e., initiator). The curing initiator may comprise peroxide capable of producing free radicals. The curing initiator comprises 2,3-dimethyl-2,3-diphenylbutane, dicumyl peroxide, t-butyl peroxybenzoate, tert-butyl peroxyisopropyl carbonate, dibenzoyl peroxide (BPO), 2,5-dimethyl-2,5-di(t-butylperoxy)-3-hexyne (25B), bis(t-butylperoxyisopropyl) benzene, azobisisobutyronitrile, or a combination thereof, but not limited thereto. For example, in one embodiment, relative to 100 parts by weight of the vinyl group-containing polyphenylene ether resin, the resin composition may further comprise 0.01 part by weight to 2.0 parts by weight of a curing accelerator, preferably 0.3 part by weight to 1.5 parts by weight of a curing accelerator, but not limited thereto.

In one embodiment, for example, the polymerization inhibitor used herein is not particularly limited and may be any polymerization inhibitor known in the field to which this disclosure pertains, including but not limited to various commercially available polymerization inhibitor products. For example, the polymerization inhibitor may comprise, but not limited to, 1,1-diphenyl-2-picrylhydrazyl radical, methyl acrylonitrile, dithioester, nitroxide-mediated radical, triphenylmethyl radical, metal ion radical, sulfur radical, hydroquinone, 4-methoxyphenol, p-benzoquinone, phenothiazine, β-phenylnaphthylamine, 4-t-butylcatechol, methylene blue, 4,4′-butylidenebis(6-t-butyl-3-methylphenol), 2,2′-methylenebis(4-ethyl-6-t-butylphenol) or a combination thereof. For example, the nitroxide-mediated radical may comprise, but not limited to, nitroxide radicals derived from cyclic hydroxylamines, such as 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include such as 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like. For example, in one embodiment, relative to a total of 100 parts by weight of the vinyl group-containing polyphenylene ether resin, the resin composition of the present disclosure may further comprise 0.001 part by weight to 2 parts by weight of polymerization inhibitor.

According to the present disclosure, for example, the coloring agent may comprise but is not limited to dye or pigment. For example, in one embodiment, relative to a total of 100 parts by weight of the vinyl group-containing polyphenylene ether resin, the resin composition of the present disclosure may further comprise 0.001 part by weight to 10 parts by weight of a coloring agent, preferably 0.01 part by weight to 5 parts by weight of a coloring agent, but not limited thereto.

According to the present disclosure, for example, the solvent may be any solvent suitable for dissolving the resin composition disclosed herein, examples including, but not limited to, methanol, ethanol, ethylene glycol monomethyl ether, acetone, butanone (methyl ethyl ketone), methyl isobutyl ketone, cyclohexanone, N-methyl-pyrrolidone, toluene, xylene, methoxyethyl acetate, ethoxyethyl acetate, propoxyethyl acetate, ethyl acetate, dimethylformamide, dimethylacetamide, propylene glycol monomethyl ether acetate, or a mixture thereof. The amount of solvent is determined in view of the purpose of completely dissolving the resin and adjusting to a certain total solid content of the resin composition. For example, in one embodiment, the amount of solvent is added to adjust the total solid content of the resin composition to 50% to 85% by weight, but not limited thereto. The solvent added to the resin composition can be evaporated and removed during the processing of the resin composition into an article such as a prepreg or a resin film, so that the insulation layer of the article such as a prepreg or resin film does not contain solvent or only contains trace amount of solvent of less than or equal to 3 wt % (i.e., 3% by weight). Therefore, the presence or absence of the solvent in the resin composition does not affect the properties of the article.

According to the present disclosure, the main purpose of adding a toughening agent is to improve the toughness of the resin composition. For example, the toughening agent suitable for the present disclosure may comprise, but not limited to, carboxyl-terminated butadiene acrylonitrile rubber (CTBN rubber), core-shell rubber, ethylene propylene rubber or a combination thereof. For example, in one embodiment, relative to a total of 100 parts by weight of the vinyl group-containing polyphenylene ether resin, the resin composition of the present disclosure may further comprise 1 part by weight to 20 parts by weight of a toughening agent, preferably 3 parts by weight to 10 parts by weight of a toughening agent, but not limited thereto.

According to the present disclosure, for example, the silane coupling agent may comprise silane (such as but not limited to siloxane), which may be further categorized according to the functional groups into amino silane, epoxide silane, vinyl silane, hydroxyl silane, isocyanate silane, methacryloxy silane and acryloxy silane. For example, in one embodiment, relative to a total of 100 parts by weight of the vinyl group-containing polyphenylene ether resin, the resin composition of the present disclosure may further comprise 0.001 part by weight to 10 parts by weight of a silane coupling agent, preferably 0.01 part by weight to 5 parts by weight of a silane coupling agent, but not limited thereto.

In addition to the aforesaid resin composition, the present disclosure further provides an article made from the aforesaid resin composition, such as an article suitable for use as components in electronic products, including but not limited to: a prepreg, a resin film, a laminate, a printed circuit board or a cured insulator. The article may comprise the resin composition at a semi-cured state (B-stage) or cured state (C-stage). The article may comprise a resin layer, wherein the resin layer is the resin composition at a semi-cured state or cured state. The article may comprise an insulation layer, wherein the insulation layer is the resin composition at a cured state.

For example, the resin composition of the present disclosure can be used to make a prepreg, which comprises a reinforcement material and a layered structure disposed thereon. The layered structure is formed by heating the resin composition at a high temperature to the semi-cured state (B-stage). Suitable baking temperature for making a prepreg may be for example 100° C. to 200° C., preferably 120° C. to 160° C. For example, the reinforcement material may be any one of a fiber material, woven fabric, and non-woven fabric, and the woven fabric preferably comprises fiberglass fabrics. The type of the fiberglass fabric is not particularly limited and may be any fiberglass fabrics used for a printed circuit board, such as E-glass fabric, D-glass fabric, S-glass fabric, T-glass fabric, L-glass fabric, Q-glass fabric or QL-glass fabric (glass fabric with hybrid structure made of Q-glass and L-glass). The fiber may comprise yarns and rovings, in spread form or standard form, and the shape of terminal face may be round or flat. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can also be optionally pre-treated by a silane coupling agent. The prepreg may be further heated and cured to the cured state (C-stage) to form an insulation layer.

For example, the resin composition of the disclosure can be used to make a resin film, which is prepared by heating and baking to semi-cure the resin composition. The resin composition may be selectively coated on a liquid crystal polymer film, a polytetrafluoroethylene film, a polyethylene terephthalate film (PET film), a polyimide film (PI film), a copper foil or a resin-coated copper (RCC), followed by heating and baking to semi-cure the resin composition to form the resin film.

For example, the resin composition of the present disclosure may be made into a laminate, which comprises at least two metal foils and at least one insulation layer disposed between the metal foils, wherein the insulation layer is made by curing the resin composition at high temperature and high pressure to the C-stage, a suitable curing temperature being for example between 180° C. and 250° C. and preferably between 210° C. and 240° C. and a suitable curing time being 80 to 180 minutes and preferably 100 to 150 minutes, a suitable lamination pressure being for example between 300 psi and 550 psi and preferably between 400 psi and 500 psi. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

In one embodiment, the laminate may be further processed by trace formation processes to obtain a printed circuit board. In one embodiment of making the printed circuit board according to the present disclosure, a double-sided copper-clad laminate (such as product EM-890, available from Elite Electronic Material (Zhongshan) Co., Ltd.) with a thickness of 28 mil and having 0.5-ounce (oz) HVLP (hyper very low profile) copper foils may be used and subject to drilling and then electroplating, so as to form electrical conduction between the top layer copper foil and the bottom layer copper foil. Then the top layer copper foil and the bottom layer copper foil are etched to form an inner layer circuit. Then brown oxidation and roughening are performed on the inner layer circuits to form uneven structures on the surface to increase roughness. Next, a vacuum lamination apparatus is used to laminate the assembly of a copper foil, the prepreg, the inner layer circuit board, the prepreg and a copper foil stacked in said order by heating at 180° C. to 250° C. for 80 to 180 minutes to cure the insulation material of the prepregs. Next, black oxidation, drilling, copper plating and other known circuit board processes are performed on the outmost copper foils so as to obtain the printed circuit board.

For example, in one embodiment, the resin composition of the present disclosure may be further made into a cured insulator, which is obtained by curing the aforementioned resin composition through a single curing process or through multiple curing processes, wherein multiple curing processes refer to curing of greater than or equal to two times. For example, the resin composition may be semi-cured (B-stage) and then further cured to the C-stage to obtain a cured insulator. The cured insulator may include the resin composition in a cured state, the resin composition in a cured state containing reinforcement materials or a combination thereof. The preferred method of semi-curing or curing is heating, such as baking heating. In one embodiment, a suitable semi-curing temperature may be for example between 100° C. and 200° C., preferably between 120° C. and 160° C. A suitable curing temperature may be for example between 180° C. and 250° C., preferably between 210° C. and 240° C. A suitable curing time may be for example 80 to 180 minutes, preferably 100 to 150 minutes. The curing (C-stage) method may be further performed under pressure.

The cured insulator may include the resin composition in a cured state. In one embodiment, the present disclosure provides a preparation method for a cured insulator, including: curing the resin film. The preparation method of the cured insulator may include: coating the resin composition on a substrate (such as a polyethylene terephthalate film (PET film), a polyimide film (PI film), a copper foil or a resin-coated copper); semi-curing the resin composition to form a resin film; and curing the resin film. The preferred method of semi-curing or curing is heating, such as baking heating.

The cured insulator may include the resin composition in a cured state containing reinforcement materials. In some embodiments, the present disclosure provides a preparation method for a cured insulator, including: curing the prepreg. The preparation method of the cured insulator may include: disposing the resin composition on the reinforcement material; semi-curing the resin composition to form a prepreg containing reinforcement materials and a semi-cured layer; and curing the prepreg. The preferred method of semi-curing or curing is heating, such as baking heating.

The preparation method of the cured insulator may include molding. For example, the resin composition or the semi-cured resin composition can be placed into a mold, and the resin composition or the semi-cured resin composition can be formed and cured in the mold under a curing temperature and a certain pressure, thereby obtaining a cured insulator with a specific shape.

The cured insulator may be an insulation layer without metal on the surface obtained by removing the metal foil on the surface of the laminate or the printed circuit board.

Preferably, the resin composition disclosed herein or an article made therefrom may achieve improvements in one or more properties including glass transition temperature, ratio of thermal expansion in Z-axis, T288 thermal resistance, flame retardancy, flame retardant migration, flame retardant detachment and bonding gap.

For example, in one embodiment, the resin composition disclosed herein or various articles made therefrom may preferably have any one, more or all of the following properties:
a glass transition temperature as measured by using dynamic mechanical analysis by reference to IPC-TM-650 2.4.24.4 of greater than or equal to 215° C., such as between 215° C. and 245° C.;
a ratio of thermal expansion in Z-axis as measured by using thermal mechanical analysis by reference to IPC-TM-650 2.4.24.5 of less than or equal to 2.60%, such as between 1.20% and 2.60%;
a time to delamination as measured by using thermal mechanical analysis by reference to IPC-TM-650 2.4.24.1 of greater than or equal to 60 minutes, such as a time to delamination of between 60 minutes and 100 minutes;
a flame retardancy of V-0 or V-1 as measured by reference to UL 94 rating, such as a flame retardancy of V-0;
no flame retardant migration in the article (such as a flame retardant migration test sample) as determined by visual inspection;
no flame retardant detachment in the article (such as a flame retardant detachment test sample) as determined by SEM inspection; and
no bonding gap in the article (such as a bonding gap test sample) as determined by SEM inspection.

Raw materials below are used to prepare the resin compositions of various Examples and Comparative Examples of the present disclosure according to the amount listed in Table 1 to Table 5 and further fabricated to prepare test samples or articles. Compositions and test results of resin compositions of various Examples and Comparative Examples of the present disclosure used herein are listed below in Table 1 to Table 5 (in part by weight).

Materials and reagents used in Examples and Comparative Examples disclosed herein are listed below:
SA9000: methacrylate group-terminated polyphenylene ether resin, available from Sabic.
OPE-2st 2200: vinylbenzyl group-terminated polyphenylene ether resin, available from Mitsubishi Gas Chemical Co., Inc.
TAIC: triallyl isocyanurate, available from Kingyorker Enterprise Co., Ltd.
BVPE: bis(vinylphenyl)ethane, available from Linchuan Chemical Co., Ltd.
ODV: styrene-divinylbenzene-ethylstyrene polymer, available from Nippon Steel & Sumikin Chemical.
Phosphorus-containing compound 1: prepared by Synthesis Example 1.
Phosphorus-containing compound 2: prepared by Synthesis Example 2.
Phosphorus-containing compound 3: prepared by Synthesis Example 3.
FCX-210: as shown below, available from Teijin Limited.

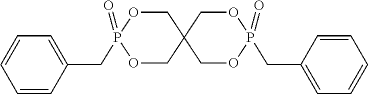 [SMILES: O=P1(Cc2ccccc2)OCC2(CO1)COP(=O)(Cc1ccccc1)OC2]

PX-200: resorcinol bis-(dixylenyl phosphate) (condensation polymer), also known as 1,3-phenylene tetrakis(2,6-dimethylphenyl) diphosphate (condensation polymer), available from Daihachi Chemical Industry Co., Ltd.
Comparative compound: as shown below, prepared according to the following method.

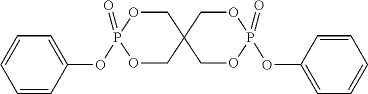 [SMILES: O=P1(Oc2ccccc2)OCC2(CO1)COP(=O)(Oc1ccccc1)OC2]

By reference to the method of Synthesis Example 1, 3 moles of 4-hydroxystyrene was replaced by 3 moles of 4-hydroxybenzene (about 282 grams), and after the reaction was completed, excess 4-hydroxybenzene was removed by rotary evaporation under reduced pressure, so as to obtain a white solid product, which is the comparative compound having the structure as shown above.
Distyryl pentaerythritol diphosphite: commercially available.
Allyl phosphate: as shown below, prepared according to the method described in CN110938234A.

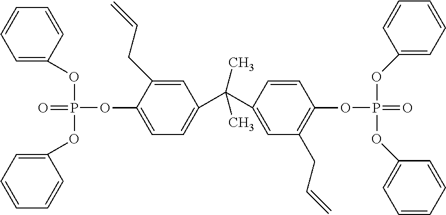 [SMILES: C=CCc1cc(C(C)(C)c2ccc(OP(=O)(Oc3ccccc3)Oc3ccccc3)c(CC=C)c2)ccc1OP(=O)(Oc1ccccc1)Oc1ccccc1]

B-1000: polybutadiene, available from Nippon Soda Co., Ltd.
Ricon 100: styrene-butadiene copolymer, available from Cray Valley.
H1052: hydrogenated styrene-butadiene-styrene triblock copolymer, available from Asahi KASEI.
25B: 2,5-dimethyl-2,5-di(t-butylperoxy)-3-hexyne, available from NOF Corporation.
SC-2500 SVJ: spherical silica pre-treated by vinyl silane coupling agent, available from Admatechs.
Toluene: available from Chambeco Group.
Methyl ethyl ketone: commercially available, source not limited.

In the Tables, “Z” represents the total amount of components excluding (i.e., not containing) curing accelerator, inorganic filler and solvent in the resin composition of each Example or each Comparative Example. For example, “Z*1.0” represents that the amount of inorganic filler is 1.0 time of “Z”. For example, in Example E1, “Z*1.0” represents that the amount of inorganic filler is 150 parts by weight (150 parts by weight multiplied by 1.0).

The amount of solvent is shown as “PA” in the Tables to indicate a “proper amount” to represent an amount of solvents used to achieve a desirable solid content of the whole resin composition. For a resin composition comprising methyl ethyl ketone and toluene as solvents, “PA” represents the total amount of the two solvents used to achieve a desirable solid content of the whole resin composition, such as but not limited to a solid content of 70 wt %.

Compositions and test results of resin compositions of Examples and Comparative Examples used herein are listed below in Table 1 to Table 5 (in part by weight):

TABLE 1
Resin compositions of Examples (in part by weight) and test results

| Component | | E1 | E2 | E3 | E4 | E5 | E6 |
|---|---|---|---|---|---|---|---|
| vinyl group-containing | SA9000 | 100 | 100 | 100 | | 100 | 100 |
| polyphenylene ether resin | OPE-2st 2200 | | | | 100 | | |
| crosslinking agent | TAIC | 30 | 30 | 30 | 30 | 10 | 40 |
| | BVPE | | | | | | |
| | ODV | | | | | | |
| phosphorus-containing flame | phosphorus-containing | 20 | 50 | 70 | 50 | 50 | 50 |
| retardant | compound 1 | | | | | | |
| | phosphorus-containing | | | | | | |
| | compound 2 | | | | | | |
| | phosphorus-containing | | | | | | |
| | compound 3 | | | | | | |
| | FCX-210 | | | | | | |
| | PX-200 | | | | | | |
| | comparative compound | | | | | | |
| | distyryl pentaerythritol | | | | | | |
| | diphosphite | | | | | | |
| | allyl phosphate | | | | | | |
| polyolefin resin | B-1000 | | | | | | |
| | Ricon 100 | | | | | | |
| | H1052 | | | | | | |
| curing accelerator | 25B | 0.5 | 0.5 | 0.5 | 0.5 | 0.5 | 0.5 |
| inorganic filler | SC-2500 SVJ | Z*1.0 | Z*1.0 | Z*1.0 | Z*1.0 | Z*1.0 | Z*1.0 |
| solvent | toluene | PA | PA | PA | PA | PA | PA |
| | MEK | PA | PA | PA | PA | PA | PA |

| Property test | Unit | E1 | E2 | E3 | E4 | E5 | E6 |
|---|---|---|---|---|---|---|---|
| DMA-Tg | ° C. | 228 | 235 | 233 | 240 | 225 | 236 |
| Z-PTE | % | 2.25 | 2.30 | 2.15 | 2.10 | 2.40 | 2.10 |
| T288 | minute | >60 | >60 | >60 | >60 | >60 | >60 |
| flame retardancy | none | V-1 | V-0 | V-0 | V-0 | V-0 | V-0 |
| flame retardant migration | none | no | no | no | no | no | no |
| flame retardant detachment | none | N | N | N | N | N | N |
| bonding gap | none | no | no | no | no | no | no |

TABLE 2
Resin compositions of Examples (in part by weight) and test results

| Component | | E7 | E8 | E9 | E10 | E11 | E12 |
|---|---|---|---|---|---|---|---|
| vinyl group-containing | SA9000 | 100 | 100 | 100 | 100 | 100 | 100 |
| polyphenylene ether resin | OPE-2st 2200 | | | | | | |
| crosslinking agent | TAIC | | | 30 | 30 | 30 | 30 |
| | BVPE | 30 | | | | | |
| | ODV | | 30 | | | | |
| phosphorus-containing flame | phosphorus-containing | 50 | 50 | | | 50 | 50 |
| retardant | compound 1 | | | | | | |
| | phosphorus-containing | | | 50 | | | |
| | compound 2 | | | | | | |
| | phosphorus-containing | | | | 50 | | |
| | compound 3 | | | | | | |
| | FCX-210 | | | | | | |
| | PX-200 | | | | | | |
| | comparative compound | | | | | | |
| | distyryl pentaerythritol | | | | | | |
| | diphosphite | | | | | | |
| | allyl phosphate | | | | | | |
| polyolefin resin | B-1000 | | | | | 15 | |
| | Ricon 100 | | | | | | 15 |
| | H1052 | | | | | | |
| curing accelerator | 25B | 0.5 | 0.5 | 0.5 | 0.5 | 0.5 | 0.5 |
| inorganic filler | SC-2500 SVJ | Z*1.0 | Z*1.0 | Z*1.0 | Z*1.0 | Z*1.0 | Z*1.0 |
| solvent | toluene | PA | PA | PA | PA | PA | PA |
| | MEK | PA | PA | PA | PA | PA | PA |

| Property test | Unit | E7 | E8 | E9 | E10 | E11 | E12 |
|---|---|---|---|---|---|---|---|
| DMA-Tg | ° C. | 245 | 226 | 235 | 215 | 235 | 224 |
| Z-PTE | % | 1.95 | 2.15 | 2.05 | 2.60 | 2.30 | 2.40 |
| T288 | minute | >60 | >60 | >60 | >60 | >60 | >60 |
| flame retardancy | none | V-0 | V-0 | V-0 | V-0 | V-0 | V-0 |
| flame retardant migration | none | no | no | no | no | no | no |
| flame retardant detachment | none | N | N | N | N | N | N |
| bonding gap | none | no | no | no | no | no | no |

TABLE 3
Resin compositions of Examples (in part by weight) and test results

| Component | | E13 | E14 | E15 | E16 | E17 |
|---|---|---|---|---|---|---|
| vinyl group-containing | SA9000 | 100 | 100 | 100 | 100 | 100 |
| polyphenylene ether resin | OPE-2st 2200 | | | | | |
| crosslinking agent | TAIC | 30 | 30 | 30 | 5 | 30 |
| | BVPE | | | | 5 | |
| | ODV | | | | 5 | |
| phosphorus-containing flame | phosphorus-containing | 50 | 50 | 50 | 50 | 50 |
| retardant | compound 1 | | | | | |
| | phosphorus-containing | | | | | |
| | compound 2 | | | | | |
| | phosphorus-containing | | | | | |
| | compound 3 | | | | | |
| | FCX-210 | | | | | |
| | PX-200 | | | | | |
| | comparative compound | | | | | |
| | distyryl pentaerythritol | | | | | |
| | diphosphite | | | | | |
| | allyl phosphate | | | | | |
| polyolefin resin | B-1000 | 5 | | | | |
| | Ricon 100 | 5 | | | | |
| | H1052 | 5 | | | | |
| curing accelerator | 25B | 0.5 | 0.1 | 2.0 | 0.5 | 0.5 |
| inorganic filler | SC-2500 SVJ | Z*1.0 | Z*1.0 | Z*1.0 | Z*0.3 | Z*2.5 |
| solvent | toluene | PA | PA | PA | PA | PA |
| | MEK | PA | PA | PA | PA | PA |

| Property test | Unit | E13 | E14 | E15 | E16 | E17 |
|---|---|---|---|---|---|---|
| DMA-Tg | ° C. | 222 | 228 | 236 | 235 | 231 |
| Z-PTE | % | 2.35 | 2.25 | 2.00 | 2.18 | 1.20 |
| T288 | minute | >60 | >60 | >60 | >60 | >60 |
| flame retardancy | none | V-0 | V-0 | V-0 | V-0 | V-0 |
| flame retardant migration | none | no | no | no | no | no |
| flame retardant detachment | none | N | N | N | N | N |
| bonding gap | none | no | no | no | no | no |

TABLE 4
Resin compositions of Comparative Examples (in part by weight) and test results

| Component | | C1 | C2 | C3 | C4 | C5 |
|---|---|---|---|---|---|---|
| vinyl group-containing | SA9000 | 100 | 100 | 100 | 100 | 100 |
| polyphenylene ether resin | OPE-2st 2200 | | | | | |
| crosslinking agent | TAIC | 30 | 30 | 30 | 30 | 30 |
| | BVPE | | | | | |
| | ODV | | | | | |
| phosphorus-containing flame | phosphorus-containing | | | | | |
| retardant | compound 1 | | | | | |
| | phosphorus-containing | | | | | |
| | compound 2 | | | | | |
| | phosphorus-containing | | | | | |
| | compound 3 | | | | | |
| | FCX-210 | 50 | | | | |
| | PX-200 | | 50 | | | |
| | comparative compound | | | 50 | | |
| | distyryl pentaerythritol | | | | 50 | |
| | diphosphite | | | | | |
| | allyl phosphate | | | | | 50 |
| polyolefin resin | B-1000 | | | | | |
| | Ricon 100 | | | | | |
| | H1052 | | | | | |
| curing accelerator | 25B | 0.5 | 0.5 | 0.5 | 0.5 | 0.5 |
| inorganic filler | SC-2500 SVJ | Z*1.0 | Z*1.0 | Z*1.0 | Z*1.0 | Z*1.0 |
| solvent | toluene | PA | PA | PA | PA | PA |
| | MEK | PA | PA | PA | PA | PA |

| Property test | Unit | C1 | C2 | C3 | C4 | C5 |
|---|---|---|---|---|---|---|
| DMA-Tg | ° C. | 202 | 180 | 203 | 182 | 195 |
| Z-PTE | % | 2.90 | 3.60 | 3.00 | 3.70 | 3.10 |
| T288 | minute | 40 | 35 | 38 | 25 | 32 |
| flame retardancy | none | V-0 | V-0 | V-0 | V-0 | V-0 |
| flame retardant migration | none | yes | yes | yes | no | no |
| flame retardant detachment | none | Y | N | Y | N | N |
| bonding gap | none | yes | no | yes | no | no |

TABLE 5
Resin compositions of Comparative Examples (in part by weight) and test results

| Component | | C6 | C7 | C8 | C9 |
|---|---|---|---|---|---|
| vinyl group-containing | SA9000 | 100 | 100 | 100 | 100 |
| polyphenylene ether resin | OPE-2st 2200 | | | | |
| crosslinking agent | TAIC | 5 | 50 | 30 | 30 |
| | BVPE | | | | |
| | ODV | | | | |
| phosphorus-containing | phosphorus-containing | 50 | 50 | 10 | 80 |
| flame retardant | compound 1 | | | | |
| | phosphorus-containing | | | | |
| | compound 2 | | | | |
| | phosphorus-containing | | | | |
| | compound 3 | | | | |
| | FCX-210 | | | | |
| | PX-200 | | | | |
| | comparative compound | | | | |
| | distyryl pentaerythritol | | | | |
| | diphosphite | | | | |
| | allyl phosphate | | | | |
| polyolefin resin | B-1000 | | | | |
| | Ricon 100 | | | | |
| | H1052 | | | | |
| curing accelerator | 25B | 0.5 | 0.5 | 0.5 | 0.5 |
| inorganic filler | SC-2500 SVJ | Z*1.0 | Z*1.0 | Z*1.0 | Z*1.0 |
| solvent | toluene | PA | PA | PA | PA |
| | MEK | PA | PA | PA | PA |

| Property test | Unit | C6 | C7 | C8 | C9 |
|---|---|---|---|---|---|
| DMA-Tg | ° C. | 205 | 238 | 220 | 235 |
| Z-PTE | % | 2.90 | 2.05 | 2.35 | 2.10 |
| T288 | minute | >60 | 10 | >60 | 40 |
| flame retardancy | none | V-0 | V-0 | V-2 | V-0 |
| flame retardant migration | none | no | no | no | no |
| flame retardant detachment | none | N | N | N | N |
| bonding gap | none | no | no | no | no |

Resin compositions from Table 1 to Table 5 were used to make varnishes and various samples (specimens) as described below and tested under conditions specified below so as to obtain the test results.

### 1. Varnish

Components of the resin composition from each Example (abbreviated as E, such as E1 to E17) or Comparative Example (abbreviated as C, such as C1 to C9) were added to a stirrer according to the amounts listed in Tables 1-5 for stirring and well-mixing to form a resin varnish.

For example, in Example E1, 100 parts by weight of a vinyl group-containing polyphenylene ether resin (SA9000), 30 parts by weight of a crosslinking agent (TAlC) and 20 parts by weight of a phosphorus-containing compound 1 were added to a stirrer containing a proper amount of toluene and a proper amount of methyl ethyl ketone (i.e., a proper amount (abbreviated as “PA”) in Tables 1-5 represents an amount of solvent suitable for obtaining a desired solid content for the resin composition, such as a solid content of the varnish being 70 wt %), and the solution was mixed and stirred to fully dissolve the solid ingredients to form a homogeneous liquid state. Then “Z*1.0” parts by weight of spherical silica (SC-2500 SVJ, i.e., 150 parts by weight) were added and well dispersed, followed by adding 0.5 part by weight of a curing accelerator (25B, pre-dissolved by a proper amount of solvent) and stirring for 1 hour to obtain the varnish of resin composition E1.

In addition, according to the components and amounts listed in Table 1 to Table 5, varnishes of Examples E2 to E17 and Comparative Examples C1 to C9 were prepared following the preparation process of the varnish of Example E1.

### 2. Prepreg (Using 2116 E-Glass Fiber Fabric)

Resin compositions from different Examples (E1 to E17) and Comparative Examples (C1 to C9) listed in Table 1 to Table 5 were respectively added to a stirred tank, well mixed and fully dissolved as varnishes and then loaded to an impregnation tank. A fiberglass fabric (e.g., 2116 E-glass fiber fabric) was passed through the impregnation tank to adhere the resin composition on the fiberglass fabric, followed by heating at 120° C. to 150° C. to the semi-cured state (B-Stage) to obtain the prepreg (resin content of about 52%).

### 3. Copper-Clad Laminate 1 (Obtained by Laminating Eight Prepregs)

Two 18 μm reverse treat foils (RTF copper foils) and eight prepregs made from each resin composition (using 2116 E-glass fiber fabrics) were prepared batchwise. Each prepreg has a resin content of about 52%. A copper foil, eight prepregs and a copper foil were superimposed in such order and then subjected to a vacuum condition for lamination at 210° C. for 2 hours to form each copper-clad laminate 1. Insulation layers were formed by curing (C-stage) eight sheets of superimposed prepreg between the two copper foils, and the resin content of the insulation layers was about 52%.

### 4. Copper-Clad Laminate 2 (Obtained by Laminating Six Prepregs)

Two 18 μm reverse treat foils (RTF copper foils) and six prepregs made from each resin composition (using 2116 E-glass fiber fabrics) were prepared batchwise. Each prepreg has a resin content of about 52%. A copper foil, six prepregs and a copper foil were superimposed in such order and then subjected to a vacuum condition for lamination at 210° C. for 2 hours to form each copper-clad laminate 2. Insulation layers were formed by curing (C-stage) six sheets of superimposed prepreg between the two copper foils, and the resin content of the insulation layers was about 52%.

### 5. Copper-Free Laminate 1 (Obtained by Laminating Eight Prepregs)

Each copper-clad laminate 1 was etched to remove the two copper foils to obtain a copper-free laminate 1, which was made from laminating eight prepregs and had a resin content of about 52%.

### 6. Copper-Free Laminate 2 (Obtained by Laminating Six Prepregs)

Each copper-clad laminate 2 was etched to remove the two copper foils to obtain a copper-free laminate 2, which was made from laminating six prepregs and had a resin content of about 52%.

For each sample, test items and test methods are described below.

### 1. Glass Transition Temperature (DMA-Tg)

The copper-free laminate 1 sample was subjected to the glass transition temperature measurement. A dynamic mechanical analyzer (DMA) was used by reference to the method described in IPC-TM-650 2.4.24.4, during which each sample was heated from 50° C. to 400° C. at a heating rate of 2° C./minute and then subjected to the measurement of glass transition temperature (DMA-Tg, in ° C.). A higher glass transition temperature is more preferred, and a difference in glass transition temperature of greater than or equal to 5° C. represents a significant difference (i.e., significant technical difficulty) in glass transition temperature of different samples.

For example, articles made from the resin composition disclosed herein have a glass transition temperature of greater than or equal to 215° C. as measured by reference to IPC-TM-650 2.4.24.4, such as between 215° C. and 245° C.

### 2. Ratio of Thermal Expansion in Z-Axis (Z-PTE)

The copper-free laminate 2 sample was subjected to thermal mechanical analysis (TMA) during the measurement of ratio of thermal expansion in Z-axis. The copper-free laminate 2 was cut into a sample with a length of 10 mm and a width of 10 mm. Each sample was heated from 35° C. to 300° C. at a temperature increase rate of 10° C./minute and then subjected to the measurement of ratio of thermal expansion (%) in Z-axis from 50° C. to 260° C. by reference to the processes described in IPC-TM-650 2.4.24.5. Lower ratio of thermal expansion in Z-axis represents a better property of the sample. Generally, a difference in ratio of thermal expansion in Z-axis of greater than or equal to 0.1% represents a substantial difference (i.e., significant technical difficulty).

For example, articles made from the resin composition disclosed herein have a ratio of thermal expansion in Z-axis as measured by reference to IPC-TM-650 2.4.24.5 of less than or equal to 2.60%, such as between 1.20% and 2.60%.

### 3. T288 Thermal Resistance

The copper-clad laminate 2 sample (6.5 mm*6.5 mm in size) was subjected to the T288 thermal resistance test. At a constant temperature of 288° C., a thermal mechanical analyzer (TMA) was used by reference to IPC-TM-6502.4.24.1 to test each sample and record the time to delamination (e.g., blistering) of the copper-clad laminate. Longer time to delamination represents better thermal resistance of the copper-clad laminate made from the resin composition. If no delamination was observed after 60 minutes in the test, a designation of “>60” was given, indicating no delamination after more than 60 minutes in the T288 thermal resistance test.

For example, articles made from the resin composition disclosed herein are characterized by a time to delamination as measured by using a thermal mechanical analyzer by reference to IPC-TM-650 2.4.24.1 of greater than or equal to 60 minutes, such as between 60 minutes and 100 minutes, or such as between 60 minutes and 80 minutes.

### 4. Flame Retardancy

The copper-free laminate 1 sample was subjected to the flame retardancy test. The flame retardancy test was performed in accordance with the UL 94 rating, and the results were represented by V-0, V-1, or V-2, wherein V-0 indicates a superior flame retardancy to V-1, and V-1 indicates a superior flame retardancy to V-2.

For example, articles made from the resin composition disclosed herein have a flame retardancy of V-0 or V-1 as measured by reference to UL 94 rating, such as a flame retardancy of V-0.

### 5. Flame Retardant Migration

The two copper-free laminate 1 samples were subjected to the flame retardant migration test. One sample was not immersed in solder, and the other sample was immersed in solder by reference to the process described in IPC-TM-650 2.4.23. The copper-free laminate 1 was immersed in a 288° C. solder bath for 20 seconds and then removed therefrom. The two copper-free laminates 1, soldered and unsoldered, were compared by visual inspection to observe if the surface of the soldered copper-free laminate 1 differs from the surface of the unsoldered copper-free laminate 1, such as becoming brighter or having foreign substances. If the surface became brighter or had foreign substances, the Fourier-transform infrared spectroscopy (FTIR) test would be conducted. The FTIR spectrum of the substances found on the surface of the copper-free laminate 1 was then compared with the FTIR spectrum of the flame retardant used in the copper-free laminate 1. If they are similar, it is confirmed that the flame retardant has migrated, recorded as “yes”. If no abnormalities are observed on the surface of the copper-free laminate 1, it is considered as absence of flame retardant migration, recorded as “no”.

### 6. Flame Retardant Detachment

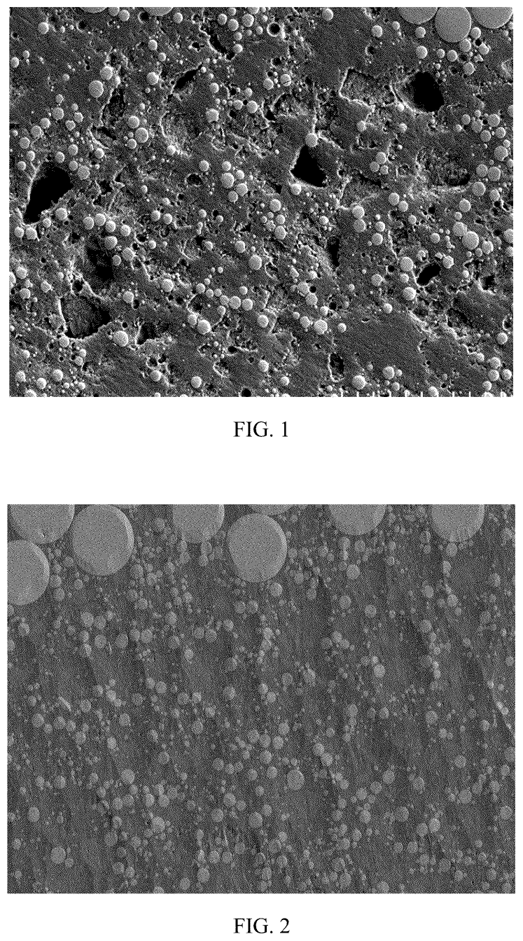

The copper-free laminate 1 sample was subjected to the flame retardant detachment test. A 1.5 cm copper-free laminate 1 sample was subjected to various slicing processes known in the art, such as resin filling, grinding, cleaning, polishing and gold plating, to make a qualified section, which was then placed in an ultrasonic cleaning machine (with ultrasonic power frequency set at 40 KHz) to vibrate for 10 minutes and then removed therefrom. After drying, the section was observed by using a scanning electron microscope (SEM). The appearance of the resin layer can be clearly observed with a magnification ranging from 500× to 2000×. 2000× magnification was used in the present disclosure to observe rectangular samples in order. When a void is observed in the sample section, as shown in FIG. 1, it is confirmed as flame retardant detachment, recorded as “Y”. When no voids are observed in the sample section, as shown in FIG. 2, it is confirmed as absence of flame retardant detachment, recorded as “N”. As used herein, the term “flame retardant detachment” refers to the separation or detachment of flame retardant from the cross-sectional surface of an article made from the resin composition of the present disclosure, such as but not limited to a copper-clad laminate or a printed circuit board.

When the flame retardant in the laminate has detachment under external force, such as under ultrasonic vibration, it is considered that the flame retardant will also have detachment during the subsequent processes of the printed circuit board (PCB). If flame retardant detachment occurs during external force such as drilling (example such as laser drilling, which involves both vibration and heating condition), it will cause uneven surfaces in the hole walls formed after drilling, leading to quality issues during electroplating circuits, potentially causing PCB reliability problems. Therefore, the absence of flame retardant detachment is one of the important quality items of the laminate.

### 7. Bonding Gap

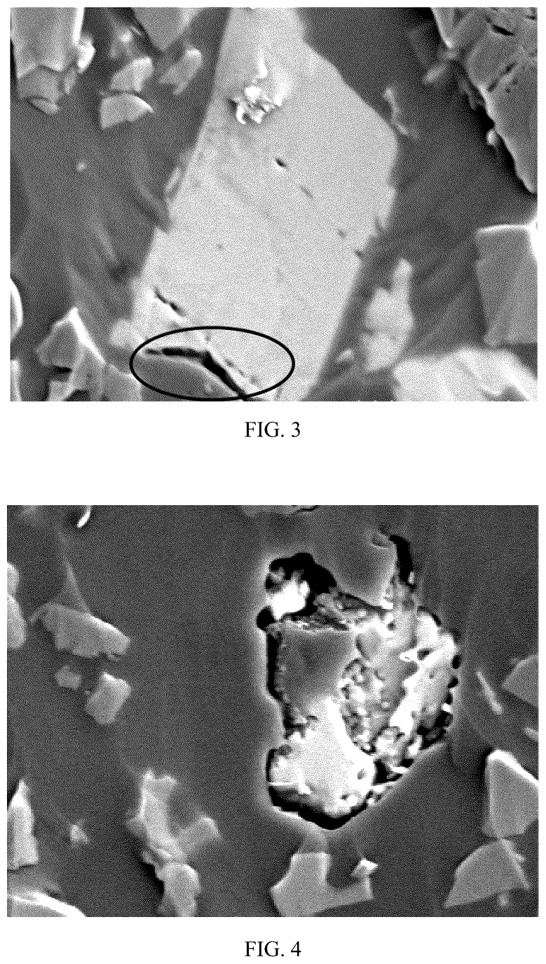

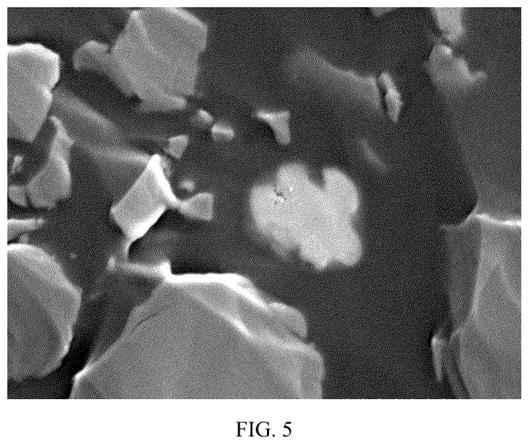

The copper-free laminate 1 sample was subjected to the bonding gap test. The test sample was cut into a rectangular sample with a length of 2.0 cm×1.5 cm from both warp and filling directions respectively, which was cleaned ultrasonically for 1 minute separately. After cleaning ultrasonically twice, the rectangular samples were subjected to various slicing processes known in the art, such as resin filling, grinding, cleaning, polishing and gold plating, to make a qualified section, which was then observed by using a scanning electron microscope (SEM). At a 20000× magnification, the presence or absence of bonding gap at the interface between the flame retardant and resin in the sample sections can be observed in order. When bonding gap is observed at the interface between the flame retardant and resin in one of the sample sections, as shown in FIG. 3 and FIG. 4, it is confirmed as presence of bonding gap, such as the strip-shaped bonding gap shown in the black circle in FIG. 3, or the annular bonding gap around the flame retardant in FIG. 4. The shape and width of the bonding gap are not particularly limited. As long as there is a bonding gap, it is recorded as “yes”. When no bonding gap is observed at the interface between the flame retardant and resin in both sample sections, as shown in FIG. 5, it is confirmed as absence of bonding gap, recorded as “no”.

When bonding gap is present at the interface between the flame retardant and resin in the laminate, it may form channels for ion migration, negatively affecting subsequent PCB reliability.

The following observations can be made from Table 1 to Table 5.

From a side-by-side comparison of Examples E2, E9 and E10 with Comparative Example C1, it can be confirmed that the phosphorus-containing compounds 1-3 disclosed herein, compared to FCX-210, can achieve one or more of the following technical effects: increasing glass transition temperature, reducing ratio of thermal expansion in Z-axis, improving T288 thermal resistance, improving flame retardant migration, improving flame retardant detachment and improving bonding gap.

From a side-by-side comparison of Examples E2, E9 and E10 with Comparative Example C3, it can be confirmed that the phosphorus-containing compounds 1-3 disclosed herein, compared to the comparative compound, can achieve one or more of the following technical effects: increasing glass transition temperature, reducing ratio of thermal expansion in Z-axis, improving T288 thermal resistance, improving flame retardant migration, improving flame retardant detachment and improving bonding gap.

From a side-by-side comparison of Examples E2, E9 and E10 with Comparative Example C4, it can be confirmed that the phosphorus-containing compound 1-3 disclosed herein, compared to distyryl pentaerythritol diphosphite, can achieve one or more of the following technical effects: increasing glass transition temperature, reducing ratio of thermal expansion in Z-axis and improving T288 thermal resistance.

From a side-by-side comparison of Examples E2, E9 and E10 with Comparative Example C2 or C5, it can be confirmed that the phosphorus-containing compounds 1-3 disclosed herein, compared to other phosphate ester flame retardants that do not contain pentaerythritol spiroheterocycles (such as PX-200 and allyl phosphate), can achieve one or more of the following technical effects: increasing glass transition temperature, reducing ratio of thermal expansion in Z-axis, improving T288 thermal resistance and improving flame retardant migration.

From a side-by-side comparison of Example E2 with Comparative Example C6 or C7, it can be confirmed that if the amount of the crosslinking agent is within the range of 10 parts by weight to 40 parts by weight, compared to the amount of 5 parts by weight or 50 parts by weight, one or more of the following technical effects can be achieved: increasing glass transition temperature, reducing ratio of thermal expansion in Z-axis and improving T288 thermal resistance.

From a side-by-side comparison of Example E2 with Comparative Example C8 or C9, it can be confirmed that if the amount of the phosphorus-containing flame retardant is within the range of 20 parts by weight to 70 parts by weight, compared to the amount of 10 parts by weight or 80 parts by weight, one or more of the following technical effects can be achieved: improving T288 thermal resistance and improving flame retardancy.

From a comparison of Examples E1 to E17 with Comparative Examples C1 to C9, it can be confirmed that the resin composition disclosed herein and the article made therefrom can achieve one, more or all of the following technical effects: a glass transition temperature of greater than or equal to 215° C., a ratio of thermal expansion in Z-axis of less than or equal to 2.60%, a time to delamination of greater than or equal to 60 minutes, a UL 94 flame retardancy of V-0 or V-1, no flame retardant migration, no flame retardant detachment and no bonding gap. In contrast, Comparative Examples C1 to C9 not using the technical solution of the present disclosure fail to achieve the aforesaid technical effects at the same time.

The above detailed description is merely illustrative in nature and is not intended to limit the embodiments of the subject matter or the application and uses of such embodiments. As used herein, the term “exemplary” means “serving as an example, instance, or illustration.” Any implementation described herein as exemplary is not necessarily to be construed as more preferred or advantageous over other implementations.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments. Also, various changes can be made in the function and arrangement of elements without departing from the scope defined by the claims, which include known equivalents and all foreseeable equivalents at the time of filing this patent application.

1. A resin composition, comprising:
100 parts by weight of a vinyl group-containing polyphenylene ether resin;
10 parts by weight to 40 parts by weight of a crosslinking agent; and
20 parts by weight to 70 parts by weight of a phosphorus-containing flame retardant, which comprises a phosphorus-containing compound represented by Formula (I): 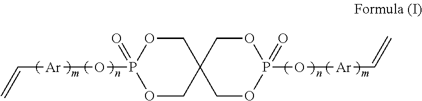
wherein m is 0 or 1, n is 0 or 1, and Ar group represents a divalent aromatic hydrocarbon group.

2. The resin composition of claim 1, wherein the vinyl group-containing polyphenylene ether resin comprises a vinylbenzyl group-terminated polyphenylene ether resin, a methacrylate group-terminated polyphenylene ether resin, an allyl group-terminated polyphenylene ether resin or a combination thereof.

3. The resin composition of claim 1, wherein the crosslinking agent comprises styrene, divinylbenzene, divinylnaphthalene, divinylbiphenyl, t-butyl styrene, bis(vinylbenzyl)ether, 1,2,4-trivinyl cyclohexane, bis(vinylphenyl)ethane, bis(vinylphenyl)hexane, bis(vinylphenyl) dimethyl ether, bis(vinylphenyl) dimethyl benzene, triallyl isocyanurate, triallyl cyanurate, diallyl bisphenol A, butadiene, decadiene, octadiene, vinylcarbazole, acrylate, styrene-divinylbenzene-ethylstyrene polymer or a combination thereof.

4. The resin composition of claim 1, wherein the divalent aromatic hydrocarbon group comprises a phenylene group, a naphthylene group, or a biphenylene group.

5. The resin composition of claim 1, wherein the phosphorus-containing compound represented by Formula (I) comprises any one phosphorus-containing compound of Formula (II), Formula (III) and Formula (IV) or a combination thereof:

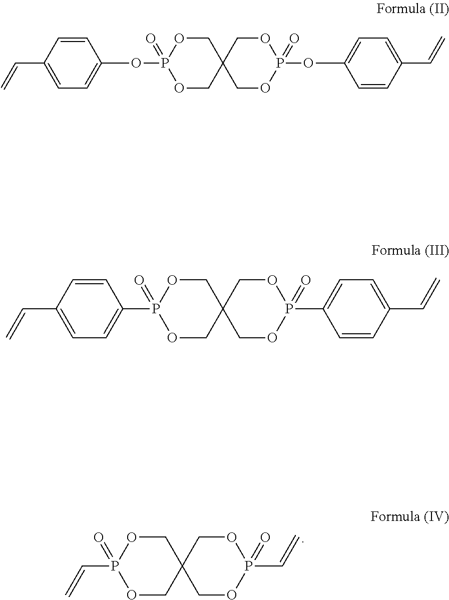

6. The resin composition of claim 1, further comprising a polyolefin resin, a styrene maleic anhydride resin, an epoxy resin, a phenolic resin, a benzoxazine resin, a cyanate ester resin, a polyester resin, a polyamide resin, a polyimide resin or a combination thereof.

7. The resin composition of claim 1, further comprising an amine curing agent, an inorganic filler, a curing accelerator, a polymerization inhibitor, a coloring agent, a solvent, a toughening agent, a silane coupling agent or a combination thereof.

8. An article made from the resin composition of claim 1, wherein the article comprises a prepreg, a resin film, a laminate, a printed circuit board or a cured insulator.

9. The article of claim 8, having a glass transition temperature as measured by using dynamic mechanical analysis by reference to IPC-TM-650 2.4.24.4 of greater than or equal to 215° C.

10. The article of claim 8, having a ratio of thermal expansion in Z-axis as measured by using thermal mechanical analysis by reference to IPC-TM-650 2.4.24.5 of less than or equal to 2.60%.

11. The article of claim 8, having a time to delamination as measured by using thermal mechanical analysis by reference to IPC-TM-650 2.4.24.1 of greater than or equal to 60 minutes.

12. The article of claim 8, having a flame retardancy of V-0 or V-1 as measured by reference to UL 94 rating.

13. The article of claim 8, having no flame retardant migration as determined by visual inspection.

14. The article of claim 8, having no flame retardant detachment as determined by scanning electron microscope inspection.

15. The article of claim 8, having no bonding gap as determined by scanning electron microscope inspection.
